(19) United States
(12) Patent Application Publication
(10) Pub. No.: US 2026/0001525 A1
(43) Pub. Date: Jan. 1, 2026

(54) MOTOR CONTROL DEVICE

(71) Applicant: HONDA MOTOR CO., LTD., Tokyo (JP)

(72) Inventors: Kento OHASHI, Tokyo (JP); Shinya Kobori, Tokyo (JP)

(73) Assignee: HONDA MOTOR CO., LTD., Tokyo (JP)

(21) Appl. No.: 19/251,821

(22) Filed: Jun. 27, 2025

(30) Foreign Application Priority Data
Jun. 28, 2024 (JP) 2024-104986

(51) Int. Cl. B60W 20/10; B60W 10/08

(52) U.S. Cl. CPC B60W 20/10; B60W 10/08; B60W 2510/081; B60W 2510/083; B60W 2510/085; B60W 2510/244; B60W 2710/083

(57) ABSTRACT

A motor control device is provided in a vehicle equipped with a motor connected to a battery. The motor control device includes a processor which derives first power consumed by the motor or output from the motor to the battery in a case where the motor operates to output a torque having a torque instruction value, derives second power consumed by the motor or output from the motor to the battery, acquires third power output from the battery or input to the battery, acquires a power limit value of the battery, corrects the power limit value to derive a control power limit value, derives a power correction amount of the first power when the first power exceeds the control power limit value, corrects the torque instruction value based on the power correction amount, and operates the motor according to the corrected torque instruction value.

### CROSS-REFERENCE TO RELATED APPLICATIONS

This application is based on and claims priority under 35 USC 119 from Japanese Patent Application No. 2024-104986 filed on Jun. 28, 2024, the entire content of which is incorporated herein by reference.

### TECHNICAL FIELD

The present disclosure relates to a motor control device.

### BACKGROUND ART

JP2004-328961A discloses a vehicle charge and discharge control device including a power storage device that stores power generated by an electric generator; an electric motor that functions as a drive source of a vehicle based on the power from the electric generator or the power storage device and charges the power storage device with power by performing regenerative power generation during braking of the vehicle; and a controller that integrally controls the power storage device and the electric motor, in which the controller includes a chargeable power calculation unit that calculates power that can be charged into the power storage device according to a state of the power storage device, and a regenerative power consumption unit that consumes power of an amount that exceeds the calculated chargeable power among regenerative power generated during the braking of the vehicle, the controller further includes a chargeable power correction value calculation unit that calculates a chargeable power correction value in which the chargeable power of the power storage device is corrected according to the chargeable power and a control error of the regenerative power consumption unit, and a chargeable power correction value switching unit that switches the chargeable power correction value according to the control error of the regenerative power consumption unit, and the regenerative power consumption unit consumes power of an amount that exceeds the chargeable power correction value among the regenerative power.

JP2003-259509A describes an electric vehicle drive control device including an electric machine; an electric machine rotational speed detection processing unit that detects an electric machine rotational speed; an efficiency calculation processing unit that calculates efficiency of the electric machine; a power limit value calculation processing unit that calculates a power limit value corresponding to a battery state; a torque limit value calculation processing unit that calculates a torque limit value of an electric machine torque based on the electric machine rotational speed, the efficiency, and the power limit value; and an electric machine target torque calculation processing unit that calculates an electric machine target torque representing a target value of the electric machine torque based on the torque limit value.

### SUMMARY OF INVENTION

An object of the present disclosure is to efficiently use power of a battery mounted on a vehicle while protecting the battery.

An aspect of the present disclosure relates to a motor control device provided in a vehicle equipped with a motor connected to a battery, the motor control device including:
a processor, in which
the processor is configured to:
acquire a torque instruction value, a rotation speed, and a power loss of the motor;
derive, based on the torque instruction value, the rotation speed, and the power loss, first power consumed by the motor or output from the motor to the battery in a case where the motor operates to output a torque having the torque instruction value;
acquire a current value and a voltage value of the motor;
derive, based on the current value and the voltage value, second power consumed by the motor or output from the motor to the battery;
acquire third power output from the battery or input to the battery;
acquire a power limit value of the battery;
correct the power limit value based on the first power, the second power, and the third power to derive a control power limit value;
derive a power correction amount of the first power in a case where the first power exceeds the control power limit value;
correct the torque instruction value based on the power correction amount; and
operate the motor according to the corrected torque instruction value.

According to the present disclosure, it is possible to efficiently use power of the battery mounted on the vehicle while protecting the battery.

### BRIEF DESCRIPTION OF DRAWINGS

Exemplary embodiment(s) of the present invention will be described in detail based on the following figures, wherein:

FIG. 1 is a schematic diagram showing a schematic configuration of a vehicle 100 equipped with a motor control device according to an embodiment of the present disclosure;

FIG. 2 is a graph illustrating control contents of a motor ECU 31 during discharging;

FIG. 3 is a graph illustrating control contents of the motor ECU 31 during charging;

FIG. 4 is a graph illustrating a method of deriving an error ΔP1;

FIG. 5 is a graph illustrating a method of deriving a power loss ΔP2;

FIG. 6 is a flowchart illustrating operations of an ICM 1;

FIG. 7 is a flowchart illustrating operations of an IPU 2;

FIG. 8 is a flowchart (part 1) illustrating operations of the motor ECU 31;

FIG. 9 is a flowchart (part 2) illustrating the operations of the motor ECU 31;

FIG. 10 is a schematic diagram showing a schematic configuration of a vehicle 200 which is a modification of the vehicle 100;

FIG. 11 is a flowchart (part 1) illustrating operations of a motor ECU 36 of the vehicle 200;

FIG. 12 is a flowchart (part 2) illustrating the operations of the motor ECU 36 of the vehicle 200;

FIG. 13 is a schematic diagram (part 1) showing a relationship between a discharge-side power limit value and a discharge-side control power limit value;

FIG. 14 is a schematic diagram (part 2) showing a relationship between the discharge-side power limit value and the discharge-side control power limit value;

FIG. 15 is a schematic diagram (part 1) showing a relationship between a charge-side power limit value and a charge-side control power limit value; and

FIG. 16 is a schematic diagram (part 2) showing a relationship between the charge-side power limit value and the charge-side control power limit value.

### DESCRIPTION OF EMBODIMENTS

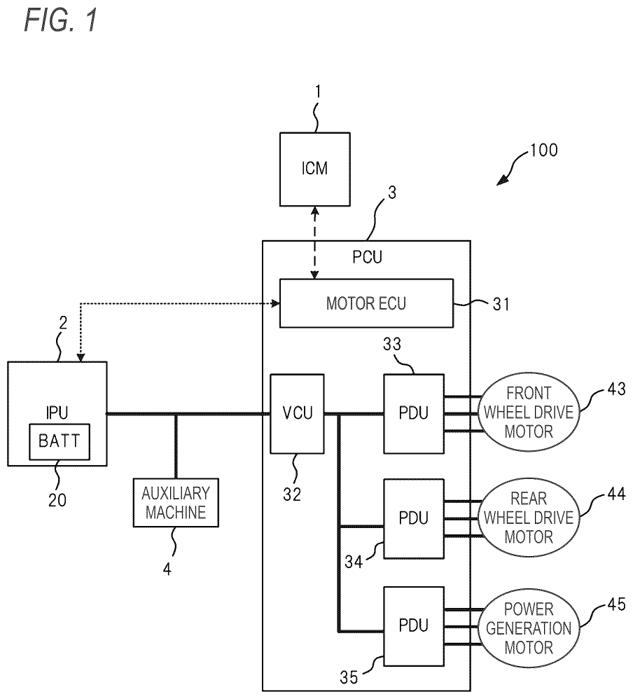

FIG. 1 is a schematic diagram showing a schematic configuration of a vehicle 100 equipped with a motor control device according to an embodiment of the present disclosure. The vehicle 100 shown in FIG. 1 is an automobile including a pair of front wheels and a pair of rear wheels. The present disclosure is applicable not only to four-wheeled vehicles but also to three-wheeled vehicles, two-wheeled vehicles, and the like.

The vehicle 100 includes an intelligent control module (ICM) 1 including a processor (not shown), an intelligent power unit (IPU) 2 including a battery 20 and a processor (not shown), a power control unit (PCU) 3, an auxiliary machine 4, a front wheel drive motor 43 capable of transmitting power to a drive shaft coupled to the front wheels, a rear wheel drive motor 44 capable of transmitting power to a drive shaft connected to the rear wheels, and a power generation motor 45 coupled to an internal combustion engine (not shown). Two front wheel drive motors 43 and two rear wheel drive motors 44 may be provided to form four motors.

A broken line arrow shown in FIG. 1 indicates a communication path. Thick solid lines shown in FIG. 1 indicate power paths. Hereinafter, each of the front wheel drive motor 43, the rear wheel drive motor 44, and the power generation motor 45 may be simply referred to as a motor.

The front wheel drive motors 43 and the rear wheel drive motors 44 operate as electric motors using power supply from the battery 20, and generate power for the vehicle 100 to travel. Torques generated by the front wheel drive motors 43 and the rear wheel drive motors 44 are transmitted to the front wheels and the rear wheels via the respective drive shafts. Each of the front wheel drive motor 43 and the rear wheel drive motor 44 may operate as an electric generator during braking of the vehicle 100.

Power generated by the power generation motor 45 is used to drive the front wheel drive motors 43 and the rear wheel drive motors 44 or to charge the battery 20. Each of the front wheel drive motor 43, the rear wheel drive motor 44, and the power generation motor 45 includes, for example, a permanent magnet synchronous motor (PMSM) or the like such as a three-phase alternating current interior permanent magnet (IPM).

The battery 20 includes, for example, a plurality of power storage cells connected in series and supplies a high voltage of, for example, 100 V to 200 V. The power storage cell is, for example, a lithium-ion battery, a nickel-hydrogen battery, or an all-solid-state battery.

The IPU 2 is provided with sensors that detect a voltage, a current, and a temperature of the battery 20. The processor of the IPU 2 can derive power (hereinafter, referred to as BAT power PB) output from the battery 20 or input to the battery 20 based on information from these sensors.

Further, the processor of the IPU 2 determines a state (state of charge (SOC) or the like) of the battery 20 based on the information from these sensors, reads information on a power limit value determined according to the state from a memory, and transmits the information to the motor ECU 31.

The power limit value of the battery 20 includes a discharge-side power limit value that is an output upper limit when the power is output from the battery 20 (during discharging), and a charge-side power limit value that is an input upper limit when the power is input to the battery 20 (during charging). A relationship between the state of the battery 20 and the power limit value is experimentally obtained or is stored in a memory or the like according to use conditions or specifications of the vehicle or the battery.

The PCU 3 includes a power drive unit (PDU) 33 connected to the front wheel drive motor 43, a PDU 34 connected to the rear wheel drive motor 44, a PDU 35 connected to the power generation motor 45, a voltage control unit (VCU) 32 connected to the PDU 33, the PDU 34, and the PDU 35, and a motor electronic control unit (ECU) 31 that integrally controls these units.

The motor ECU 31 includes a processor such as a central processing unit (CPU) and a memory. The motor ECU 31 may include a single processor or a plurality of processors. The processor is hardware that performs various processes by executing programs, and a specific configuration thereof is an electric circuit.

When the front wheel drive motor 43 and the rear wheel drive motor 44 operate as electric motors, the VCU 32 boosts a direct current voltage from the battery 20 and supplies the boosted direct current voltage to the PDU 33 and the PDU 34. When the front wheel drive motor 43 and the rear wheel drive motor 44 operate as electric generators, the VCU 32 steps down direct current voltages supplied from the PDU 33 and the PDU 34 and inputs the stepped-down direct current voltages to the battery 20. When the power generation motor 45 generates power, the VCU 32 steps down a direct current voltage supplied from the PDU 35 and inputs the stepped-down direct current voltage to the battery 20. The VCU 32 performs voltage boosting and step-down by controlling a built-in switching element. Therefore, in the VCU 32, power loss due to switching may occur.

When the front wheel drive motor 43 operates as an electric motor, the PDU 33 converts an output voltage of the VCU 32 into an alternating current. The PDU 33 converts an alternating current generated by the front wheel drive motor 43 into a direct current during braking of the vehicle 100.

When the rear wheel drive motor 44 operates as an electric motor, the PDU 34 converts the output voltage of the VCU 32 into an alternating current. The PDU 34 converts an alternating current generated by the rear wheel drive motor 44 into a direct current during braking of the vehicle 100.

When the power generation motor 45 generates power, the PDU 35 converts an alternating current generated by the power generation motor 45 into a direct current. Each of the PDU 33, the PDU 34, and the PDU 35 performs conversion between the alternating current and the direct current by controlling a switching element. Therefore, power loss due to switching may occur in each of the PDU 33, the PDU 34, and the PDU 35.

Each of the PDU 33, the PDU 34, and the PDU 35 performs vector control, generates a d-axis current instruction value Id and a q-axis current instruction value Iq based on a d-axis voltage instruction value Vd, a q-axis voltage instruction value Vq, and the like received from the motor ECU 31, and supplies a three-phase alternating current based on a respective one of these instruction values to a coil of the corresponding motor.

Each of the front wheel drive motor 43, the rear wheel drive motor 44, and the power generation motor 45 is provided with a rotation speed sensor that detects a rotation speed. Information on the rotation speed of each motor is transmitted to the motor ECU 31.

Each of the front wheel drive motor 43, the rear wheel drive motor 44, and the power generation motor 45 is provided with a current sensor that detects a three-phase alternating current flowing through the corresponding coil. Information on the three-phase alternating current of each motor is transmitted to the motor ECU 31.

The power consumed by the motor when the motor is operating or the power output from the motor to the battery 20 is referred to as motor power. Hereinafter, the motor power of the front wheel drive motor 43 is referred to as motor power P43, the motor power of the rear wheel drive motor 44 is referred to as motor power P44, and the motor power of the power generation motor 45 is referred to as motor power P45. The motor power P45 is power output from the power generation motor 45 to the battery 20.

The motor power can be derived by multiplying a d-axis current value Id and a q-axis current value Iq, which are obtained by dq conversion of the three-phase alternating current detected by the current sensor provided in the motor, by the d-axis voltage instruction value Vd and the q-axis voltage instruction value Vq of the motor, that is, (Id×Vd+Iq×Vq).

Each of the motor power P43 and the motor power P44 has a value with a positive sign in a case where the power is consumed by the motor. Each of the motor power P43 and the motor power P44 has a value with a negative sign in a case where the power is output from the motor to the battery 20 (that is, the power is generated). The motor power P45 is power output from the motor to the battery 20, and thus has a value with a negative sign.

For example, it is assumed that the front wheel drive motor 43 and the rear wheel drive motor 44 operate as electric motors, and the power generation motor 45 generates power. In this case, power obtained by adding a power loss ΔP2 (a switching loss in each PDU, a switching loss in the VCU 32, a loss in the auxiliary machine 4, and the like) in the power path from the battery 20 to each motor to a value obtained by calculation of (P43+P44+(−P45)) is power output from the battery 20.

Further, it is assumed that the front wheel drive motor 43 and the rear wheel drive motor 44 operate as electric generators, and the power generation motor 45 generates power. In this case, a value obtained by subtracting the power loss ΔP2 from an absolute value of a value obtained by calculation of ((−P43)+(−P44)+(−P45)) is power input to the battery 20.

The processor of the motor ECU 31 controls the motor power P43, the motor power P44, and the motor power P45 such that the BAT power PB does not exceed the power limit value. However, since the information on the BAT power PB is transmitted from the IPU 2 to the motor ECU 31 through a communication line, a delay occurs. That is, the processor of the motor ECU 31 cannot monitor the BAT power PB in real time.

Therefore, in the present embodiment, at a time point when acquiring a torque instruction value of each motor from the ICM 1, the processor of the motor ECU 31 acquires the rotation speed of each motor from the rotation speed sensor, and acquires, from the memory, the power loss (motor loss) of the motor determined by the state of the motor. The motor loss is experimentally obtained and stored in advance in the memory of the motor ECU 31.

The processor of the motor ECU 31 derives, based on the torque instruction value, the rotation speed, and the motor loss acquired for each motor, estimated power consumed by the motor or output from the motor to the battery 20 when the motor operates to output a torque having the torque instruction value.

Specifically, the estimated power of each motor is derived by calculation (torque instruction value+correction torque in motor)× rotation speed+motor loss. The correction torque in the motor is a value experimentally obtained for each motor or a value corrected in real time by feedback from the rotation speed of the motor. The motor loss has a positive value when the motor consumes power, and has a negative value when the motor generates power.

The estimated power consumed by the front wheel drive motor 43 or the estimated power output from the front wheel drive motor 43 to the battery 20 is referred to as estimated power Pf. The estimated power consumed by the rear wheel drive motor 44 or the estimated power output from the rear wheel drive motor 44 to the battery 20 is referred to as estimated power Pr. The estimated power output from the power generation motor 45 to the battery 20 is referred to as estimated power Pg. Power obtained by adding the estimated power Pf, the estimated power Pr, and the estimated power Pg is referred to as total estimated power PE.

When the estimated power Pf and the estimated power Pr are power consumed by the motor, the estimated power Pf and the estimated power Pr each have a value with a positive sign. In a case where each of the estimated power Pf and the estimated power Pr is power output from the motor to the battery 20, the estimated power Pf and the estimated power Pr each have a value with a negative sign except for when the power is wasted. Since the estimated power Pg is power output from the motor to the battery 20, the estimated power Pg has a value with a negative sign except for when the power is wasted.

When the front wheel drive motor 43 and the rear wheel drive motor 44 operate as electric motors, the total estimated power PE is obtained by calculation (Pf+Pr+(−Pg)). When the front wheel drive motor 43 and the rear wheel drive motor 44 operate as electric generators, the total estimated power PE is obtained as an absolute value of a value obtained by calculation ((−Pf)+(−Pr)+(−Pg)).

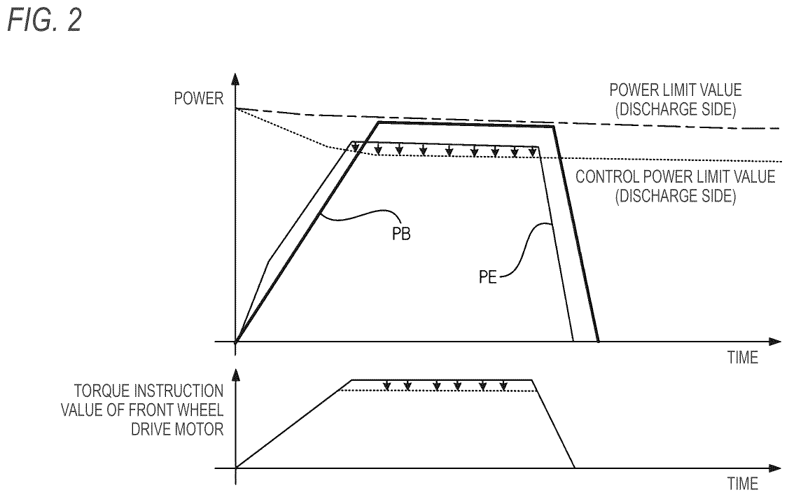

FIG. 2 is a graph illustrating control contents of the motor ECU 31 during discharging. In FIG. 2, for simplification, it is assumed that the torque instruction values of the rear wheel drive motor 44 and the power generation motor 45 are 0. As described above, the BAT power PB cannot be monitored in real time. Therefore, the processor of the motor ECU 31 controls the BAT power PB so as not to exceed the discharge-side power limit value by using the total estimated power PE and a control power limit value.

Specifically, the processor of the motor ECU 31 basically derives, as the control power limit value, a value smaller than the discharge-side power limit value (a value obtained by subtracting a discharging correction amount to be described later from the discharge-side power limit value), although the value may change in response to the error. When the total estimated power PE derived at the time point when the torque instruction value is acquired from the ICM 1 exceeds the control power limit value, the processor of the motor ECU 31 corrects the total estimated power PE to the control power limit value (see downward arrows in an upper part of FIG. 2).

The processor of the motor ECU 31 converts the corrected total estimated power PE into a torque instruction value in consideration of the motor loss of each motor. As shown in a lower part of FIG. 2, the converted torque instruction value is changed to a value smaller than the original torque instruction value (see downward arrows in the lower part of FIG. 2). The processor of the motor ECU 31 drives each motor to output a torque having the converted torque instruction value. Accordingly, the BAT power PB changes as shown in the upper part of FIG. 2.

Assuming that there is no error in the motor loss of each motor, when each motor is driven to generate the torque having the converted torque instruction value shown in FIG. 2, a value obtained by adding the power loss ΔP2 generated in the power path from the battery 20 to each motor to the corrected total estimated power PE is output from the battery 20.

However, in actuality, the motor loss may include an error. An error ΔP1 of the motor loss in the three motors as a whole takes a positive value in a direction in which the loss increases and takes a negative value in a direction in which the loss decreases.

When the error ΔP1 takes a positive value, power obtained by adding the error ΔP1 and the power loss ΔP2 to the control power limit value is an upper limit of power output from the battery 20. Therefore, by making the discharging correction amount equal to a sum of the error ΔP1 (positive value) and the power loss ΔP2, the power output from the battery 20 does not exceed the discharge-side power limit value.

Accordingly, the BAT power PB can be prevented from exceeding the discharge-side power limit value while bringing the upper limit of the BAT power PB as close as possible to the discharge-side power limit value. Therefore, the battery 20 can be protected and the power of the battery 20 can be efficiently used.

When the error ΔP1 takes a negative value, power obtained by adding the power loss ΔP2 to the control power limit value, and further subtracting an absolute value of the error ΔP1 is the upper limit of power output from the battery 20. In this case as well, by making the discharging correction amount equal to the sum of the error ΔP1 (negative value) and the power loss ΔP2, the power output from the battery 20 does not exceed the discharge-side power limit value.

Accordingly, the BAT power PB can be prevented from exceeding the discharge-side power limit value while bringing the upper limit of the BAT power PB as close as possible to the discharge-side power limit value. Therefore, the battery 20 can be protected and the power of the battery 20 can be efficiently used.

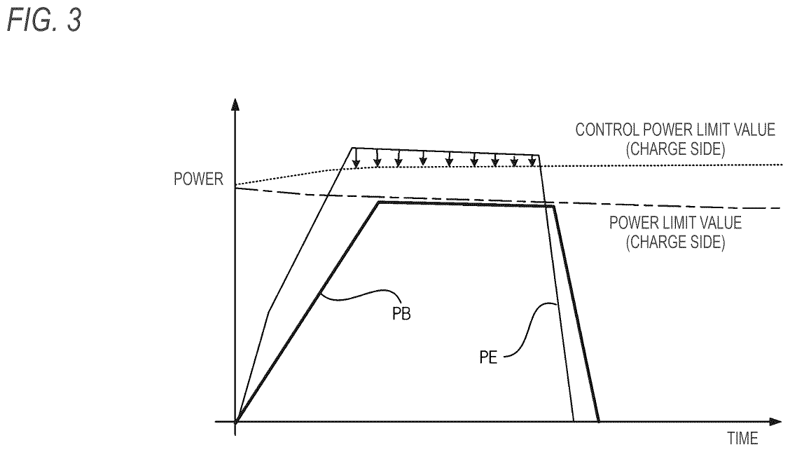

FIG. 3 is a graph illustrating control contents of the motor ECU 31 during charging on a negative side when a case of the discharging in FIG. 2 is set to be on a positive side. During the charging (during regenerative operation of the front wheel drive motor 43 and the rear wheel drive motor 44), the processor of the motor ECU 31 derives a value larger than the charge-side power limit value (a value obtained by adding a charging correction amount to the charge-side power limit value) as the control power limit value.

When the total estimated power PE derived at the time point when the torque instruction value is acquired from the ICM 1 exceeds the control power limit value, the processor of the motor ECU 31 corrects the total estimated power PE to the control power limit value (see downward arrows in FIG. 3). The processor of the motor ECU 31 converts the corrected total estimated power PE into a torque instruction value in consideration of the motor loss of each motor.

When the error ΔP1 takes a positive value, power obtained by subtracting the error ΔP1 from the control power limit value and further subtracting the power loss ΔP2 is an upper limit of power input to the battery 20. Therefore, by making a difference (charging correction amount) between the control power limit value and the charge-side power limit value in FIG. 3 equal to the sum of the error ΔP1 and the power loss ΔP2, the power input to the battery 20 can be prevented from exceeding the charge-side power limit value.

Accordingly, the BAT power PB can be prevented from exceeding the charge-side power limit value while bringing the upper limit of the BAT power PB as close as possible to the charge-side power limit value. Therefore, the battery 20 can be protected and the battery 20 can be efficiently charged.

When the error ΔP1 takes a negative value, power obtained by adding the error ΔP1 (absolute value) and the control power limit value and further subtracting the power loss ΔP2 is the upper limit of power input to the battery 20. Therefore, by making the charging correction amount equal to the sum of the error ΔP1 (negative value) and the power loss ΔP2, the power input to the battery 20 can be prevented from exceeding the charge-side power limit value.

Accordingly, the BAT power PB can be prevented from exceeding the charge-side power limit value while bringing the upper limit of the BAT power PB as close as possible to the charge-side power limit value. Therefore, the battery 20 can be protected and the battery 20 can be efficiently charged.

In this way, the control power limit value is derived by correcting the power limit value based on the error ΔP1 of the motor losses in the three motors as a whole and the power loss ΔP2. The error ΔP1 and the power loss ΔP2 may vary depending on situations and thus are difficult to be experimentally determined in advance.

Therefore, the processor of the motor ECU 31 derives the error ΔP1 based on a total motor power PM, which is a total value of the motor power of the respective motors, and the total estimated power PE. The processor of the motor ECU 31 derives the power loss ΔP2 based on the total motor power PM and the BAT power PB.

In other words, the processor of the motor ECU 31 corrects the power limit value based on the total motor power PM, the total estimated power PE, and the BAT power PB to derive the control power limit value.

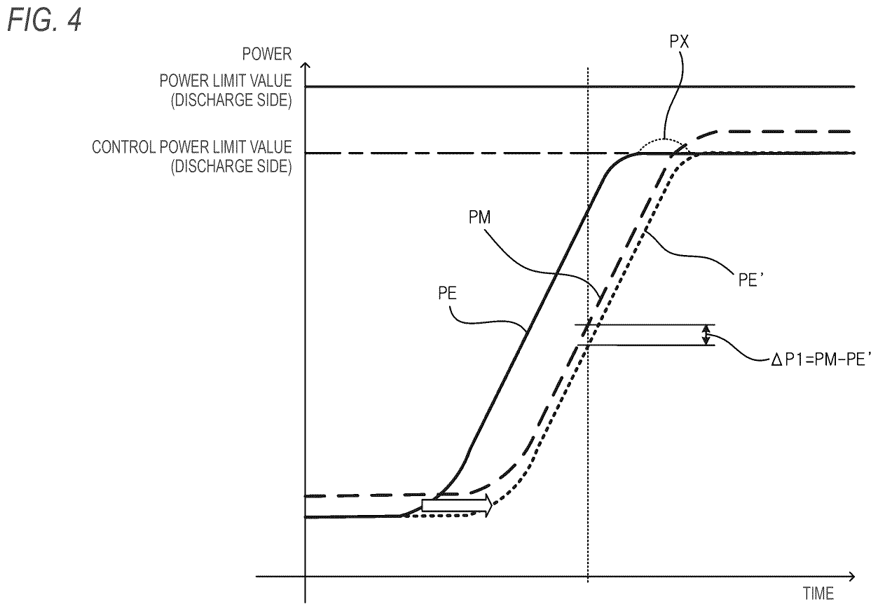

FIG. 4 is a graph illustrating a method of deriving the error ΔP1. FIG. 4 shows an example of temporal changes in the total estimated power PE and the total motor power PM. The total motor power PM is a value when each motor operates to output a torque according to the torque instruction value immediately before a timing at which the total estimated power PE is derived. Therefore, there is a time lag between the total estimated power PE and the total motor power PM.

The processor of the motor ECU 31 derives the error ΔP1 by obtaining a difference between the total estimated power PE and the total motor power PM after eliminating the time lag between the total estimated power PE and the total motor power PM.

First, when the derived total estimated power PE exceeds the control power limit value derived at the time of the previous reception of the torque instruction value, the processor of the motor ECU 31 corrects the total estimated power PE to the control power limit value. In the example of FIG. 4, a portion PX indicated by a broken line in the drawing is corrected to the control power limit value.

Next, the processor of the motor ECU 31 delays the corrected total estimated power PE by using a ring buffer and a low-pass filter (see white arrows in the drawing).

Next, the processor of the motor ECU 31 derives a difference value between a delayed total estimated power PE′ and the total motor power PM as the error ΔP1 of the motor loss in the three motors as a whole. During charging, the error ΔP1 can also be derived by the same method.

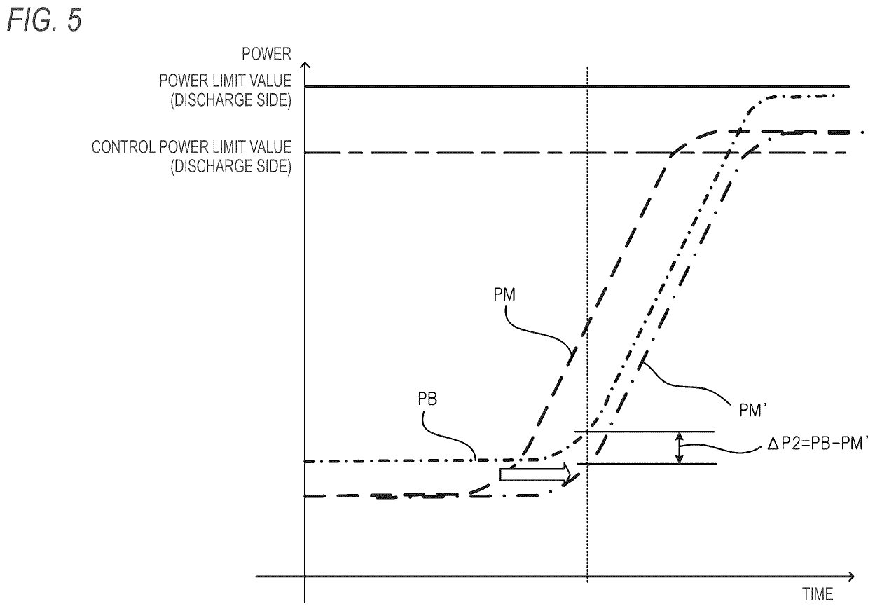

FIG. 5 is a graph illustrating a method of deriving the power loss ΔP2. FIG. 5 shows an example of temporal changes in the total motor power PM and the BAT power PB. The BAT power PB reaches the motor ECU 31 with a delay from a timing at which the total motor power PM is derived. Therefore, there is a time lag between the BAT power PB and the total motor power PM.

The processor of the motor ECU 31 derives the power loss ΔP2 by obtaining a difference between the BAT power PB and the total motor power PM after eliminating the time lag between the BAT power PB and the total motor power PM.

First, the processor of the motor ECU 31 delays the total motor power PM by using a ring buffer and a low-pass filter (see a white arrow in the drawing). The processor of the motor ECU 31 derives a difference value (absolute value) between a delayed total motor power PM′ and the BAT power PB as the power loss ΔP2. During charging, the power loss ΔP2 can also be derived by the same method.

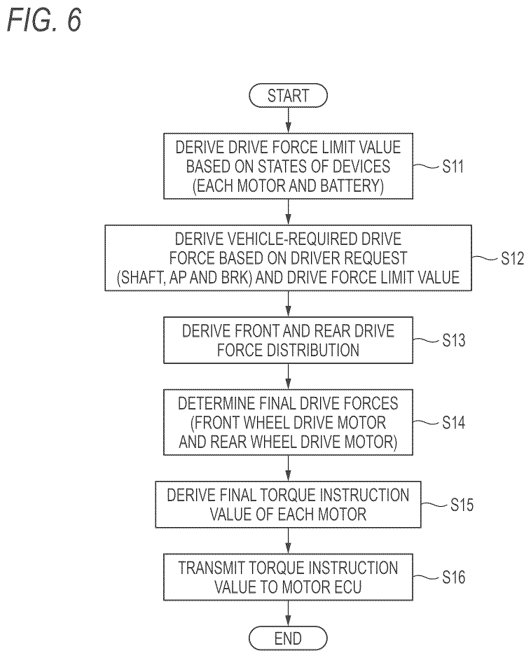

FIG. 6 is a flowchart illustrating operations of the processor of the ICM 1.

The processor of the ICM 1 derives a drive force limit value based on the states of the three motors and the battery 20 (step S11). Next, the processor of the ICM 1 acquires a driver request based on information such as a shift operation, an accelerator pedal operation, and a brake operation and derives a vehicle-required drive force based on the driver request and the drive force limit value derived in step S11 (step S12).

Next, the processor of the ICM 1 derives a distribution of the drive force among the front wheels and the rear wheels (step S13). Next, the processor of ICM 1 determines a final drive force of the front wheel drive motor 43, a final drive force of the rear wheel drive motor 44, and a final drive force of the internal combustion engine (step S14).

Next, the processor of ICM 1 derives a final torque instruction value of each motor (step S15), and transmits information indicating the torque instruction value of each motor to the motor ECU 31 (step S16).

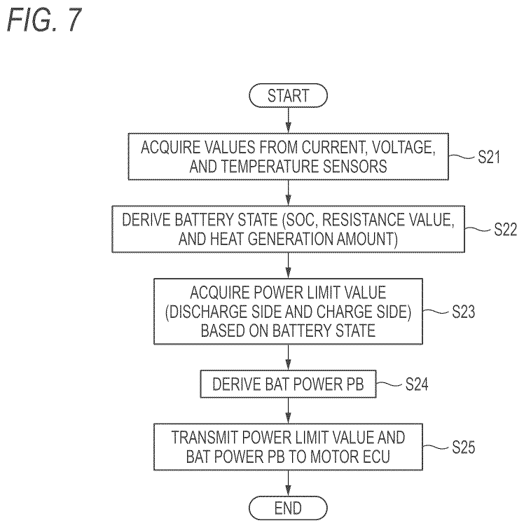

FIG. 7 is a flowchart illustrating operations of the processor of the IPU 2.

The processor of the IPU 2 acquires the current, the voltage, and the temperature of the battery 20 from the sensors provided in the IPU 2 (step S21). Next, the processor of the IPU 2 derives a battery state such as the SOC, a resistance value, and a heat generation amount of the battery 20 (step S22).

Next, the processor of the IPU 2 acquires, based on the derived battery state, the power limit value of the battery 20 corresponding to the battery state from a map stored in the memory (step S23).

Next, the processor of the IPU 2 derives the BAT power PB, which is the power output from the battery 20 or input to the battery 20, based on the current and the voltage acquired in step S21 (step S24).

Next, the processor of IPU 2 transmits information indicating the power limit value acquired in step S23 and the BAT power PB derived in step S24 to the motor ECU 31 (step S25).

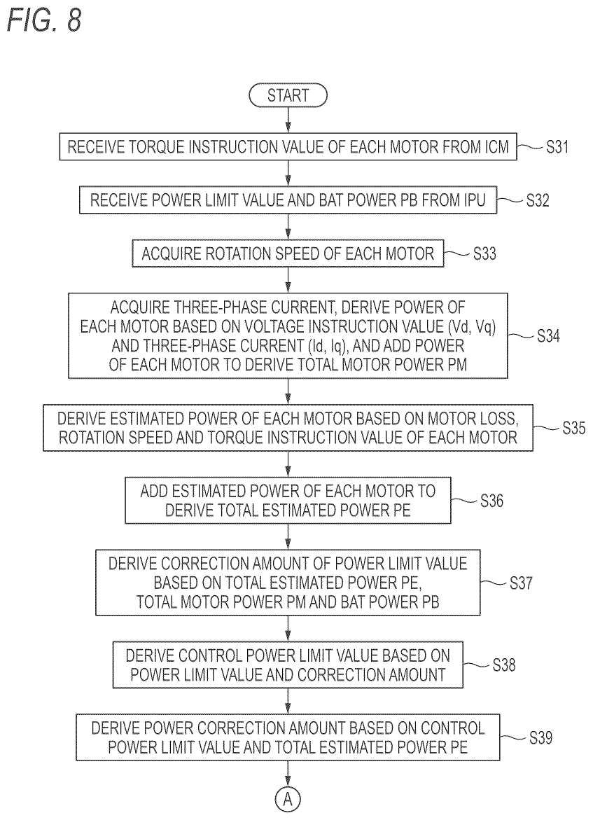

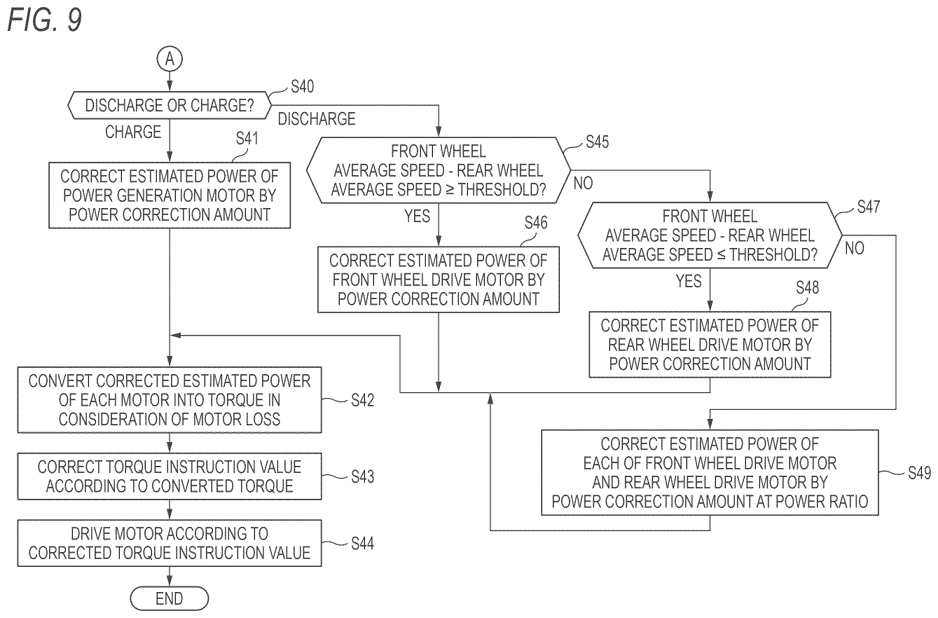

FIGS. 8 and 9 are flowcharts illustrating operations of the motor ECU 31. The processor of the motor ECU 31 receives the torque instruction value of each motor from the ICM 1 (step S31), and receives the power limit value and the BAT power PB from the IPU 2 (step S32). The processor of the motor ECU 31 acquires the rotation speed of each motor from the rotation speed sensor provided in each motor (step S33).

The processor of the motor ECU 31 acquires a three-phase alternating current value from the current sensor provided in each motor. The processor of the motor ECU 31 derives the motor power P43 of the front wheel drive motor 43, the motor power P44 of the rear wheel drive motor 44, and the motor power P45 of the power generation motor 45 based on the d-axis voltage instruction value and the q-axis voltage instruction value of each motor and the acquired three-phase alternating current value of each motor, and adds the power to derive the total motor power PM (step S34).

Further, the processor of the motor ECU 31 acquires, from the memory, the motor loss determined by a combination of the torque instruction value received in step S31 and the rotation speed acquired in step S33, and derives the estimated power for each motor based on the motor loss, the torque instruction value, and the rotation speed (step S35).

After step S35, the processor of the motor ECU 31 adds the estimated power of each motor to derive the total estimated power PE (step S36). Based on the BAT power PB received in step S32, the total motor power PM derived in step S34, and the total estimated power PE derived in step S36, the processor of the motor ECU 31 derives the correction amount (discharging correction amount or charging correction amount) of the power limit value received in step S32 by the above-described method (step S37).

After step S37, the processor of the motor ECU 31 derives the control power limit value based on the power limit value received in step S32 and the correction amount derived in step S37 (step S38).

Next, the processor of the motor ECU 31 derives a power correction amount of the total estimated power PE (a difference between the total estimated power PE and the control power limit value when the total estimated power PE exceeds the control power limit value) based on the control power limit value derived in step S38 and the total estimated power PE derived in step S36 (step S39).

When the total estimated power PE is input to the battery 20 (step S40: charge), the processor of the motor ECU 31 performs correction to decrease the estimated power Pg of the power generation motor 45 by the power correction amount derived in step S39 (step S40). That is, the total estimated power PE is controlled so as not to exceed the control power limit value by decreasing the power generated by the power generation motor 45.

When the total estimated power PE is output from the battery 20 (step S40: discharge), the processor of the motor ECU 31 acquires an average rotational speed of the front wheels and an average rotational speed of the rear wheels, or the motor rotation speed.

Then, when the average rotational speed of the front wheels is larger than the average rotational speed of the rear wheels by a threshold or more (step S45: YES), the processor of the motor ECU 31 performs correction to decrease the estimated power Pf of the front wheel drive motor 43 by the power correction amount derived in step S39 (step S46). That is, the total estimated power PE is controlled so as not to exceed the control power limit value by decreasing the power consumed by the front wheel drive motor 43. The determination in step S45 is YES, for example, in a state where only the front wheels among the front wheels and the rear wheels are slipping.

When the average rotational speed of the front wheels is not larger than the average rotational speed of the rear wheels by the threshold or more (step S45: NO), the processor of the motor ECU 31 determines whether the average rotational speed of the rear wheels is larger than the average rotational speed of the front wheels by the threshold or more (step S47).

When the determination in step S47 is YES, the processor of the motor ECU 31 performs correction to decrease the estimated power Pr of the rear wheel drive motor 44 by the power correction amount derived in step S39 (step S48). That is, the total estimated power PE is controlled so as not to exceed the control power limit value by decreasing the power consumed by the rear wheel drive motor 44. The determination in step S47 is YES, for example, in a state where only the rear wheels among the front wheels and the rear wheels are slipping.

When the determination in step S47 is NO, the processor of the motor ECU 31 distributes the power correction amount derived in step S39 to the front wheel drive motor 43 and the rear wheel drive motor 44 at a power ratio between the estimated power Pf of the front wheel drive motor 43 and the estimated power Pr of the rear wheel drive motor 44. Then, the processor of the motor ECU 31 performs correction to decrease the estimated power Pf of the front wheel drive motor 43 by a power correction amount distributed to the front wheel drive motor 43, and performs correction to decrease the estimated power Pr of the rear wheel drive motor 44 by a power correction amount distributed to the rear wheel drive motor 44 (step S49).

After step S41, step S46, step S48, or step S49, the processor of the motor ECU 31 converts the corrected estimated power of each motor into a torque in consideration of the motor loss of the motor (step S42).

Next, the processor of the motor ECU 31 corrects the torque instruction value such that the torque instruction value of each motor received in step S31 matches the converted torque obtained in step S42 (step S43).

Thereafter, the processor of the motor ECU 31 performs control to drive each motor according to the torque instruction value corrected in step S43 (step S44).

An execution order of step S31 to step S36 in FIGS. 8 and 9 may be freely set as long as there is no contradiction. For example, step S35 may be performed after step S31 and step S33, may be performed in parallel with step S32 or step S34, or may be performed before step S32 or step S34. Further, step S31 to step S34 may be performed in parallel or may be performed in any order.

According to the vehicle 100 having the above configuration, the power of the battery 20 can be consumed without waste and the battery 20 can be efficiently charged while protection is achieved by preventing over-discharge and over-charge of the battery 20.

Although the vehicle 100 includes three motors, the present disclosure may be applicable to a configuration in which any one of the three motors is omitted or a configuration in which the power generation motor 45 and any one of the front wheel drive motor 43 and the rear wheel drive motor 44 are omitted.

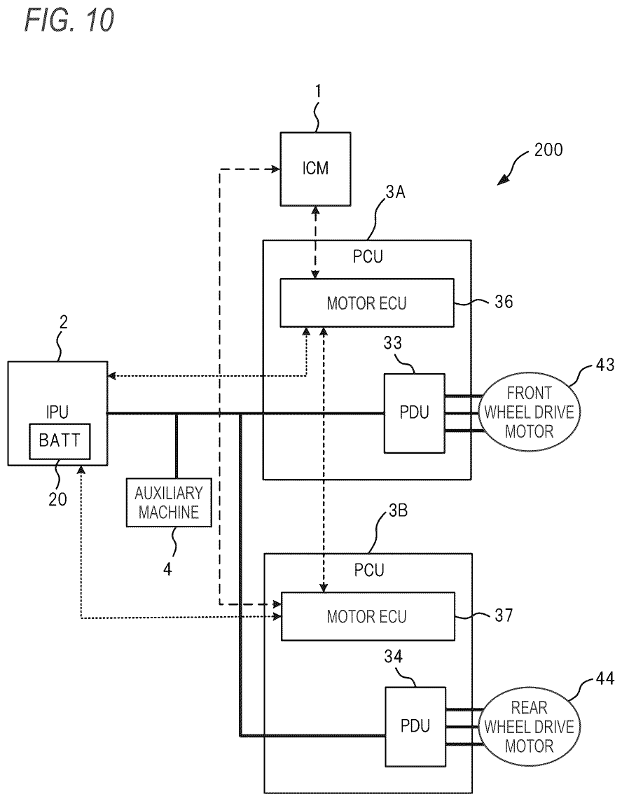

FIG. 10 is a schematic diagram showing a schematic configuration of a vehicle 200 which is a modification of the vehicle 100. The vehicle 200 has a configuration in which the VCU 32, the PDU 35, and the power generation motor 45 are removed from the vehicle 100, and the PCU 3 is divided into PCU 3A and PCU 3B. Broken line arrows shown in FIG. 10 indicate communication paths. Thick solid lines shown in FIG. 10 indicate power paths.

The PCU 3A includes the PDU 33 and a motor ECU 36 that controls the PDU 33. The PCU 3B includes the PDU 34 and a motor ECU 37 that controls the PDU 34. Each of the motor ECU 36 and the motor ECU 37 is configured to communicate with the ICM 1 and the IPU 2. The motor ECU 36 and motor ECU 37 are configured to communicate with each other.

The PCU 3A and the PCU 3B do not have to be physically separated, but even in this case, the motor ECU 36 and the motor ECU 37 are provided separately.

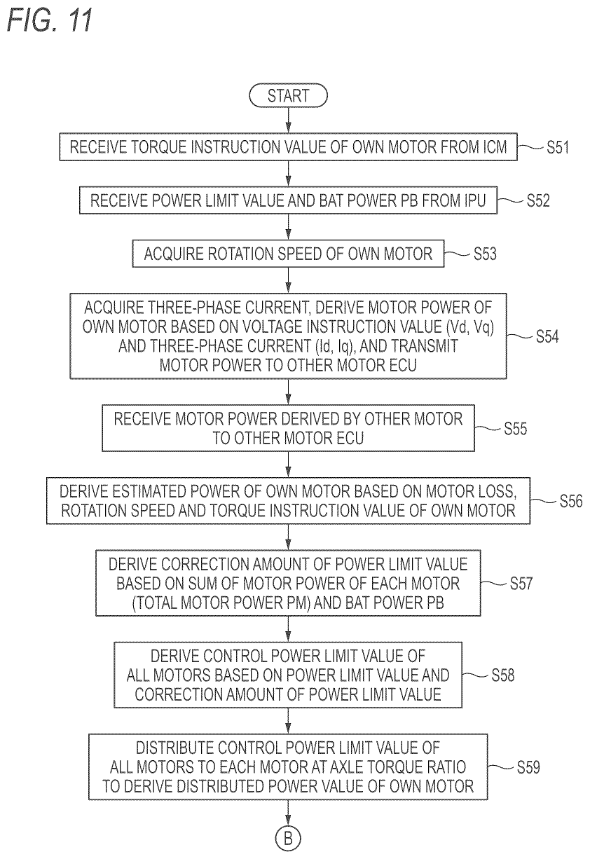

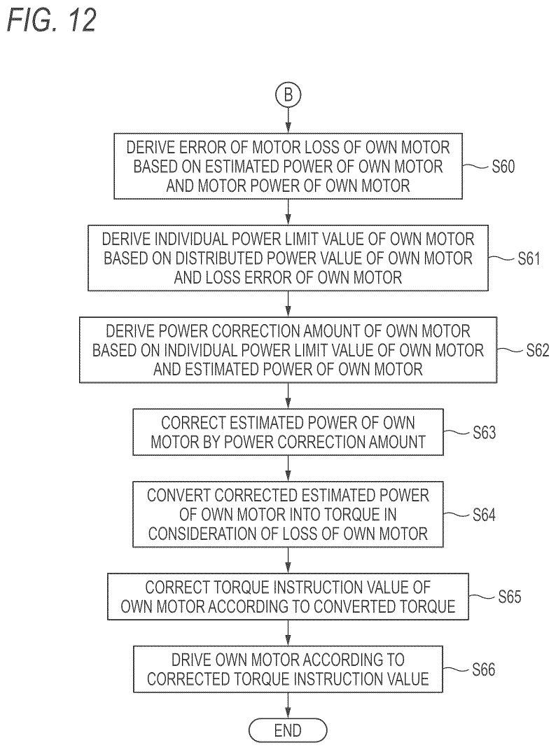

FIGS. 11 and 12 are flowcharts showing operations of the motor ECU 36 of the vehicle 200. Since operations of the motor ECU 37 of the vehicle 200 are the same as the operations of the motor ECU 36, the description thereof will be omitted.

Hereinafter, the front wheel drive motor 43 connected to the PDU 33 controlled by the motor ECU 36 will be referred to as an own motor. Regarding the operations of the motor ECU 37, the own motor in the following description may be read as the rear wheel drive motor 44.

A processor of the motor ECU 36 receives the torque instruction value of the own motor from the ICM 1 (step S51) and receives the power limit value and the BAT power PB from the IPU 2 (step S52). The processor of the motor ECU 36 acquires the rotation speed of the own motor from the rotation speed sensor provided in the own motor (step S53).

Further, the processor of the motor ECU 36 acquires the three-phase alternating current value from the current sensor provided in the own motor. The processor of the motor ECU 36 derives motor power of the own motor (the same as the motor power P43 described above) based on the d-axis voltage instruction value and the q-axis voltage instruction value of the own motor and the acquired three-phase alternating current value of the own motor, and transmits information indicating the derived motor power to another motor ECU (motor ECU 37) (step S54). A processor of the motor ECU 37 transmits, to the motor ECU 36, information indicating motor power of the rear wheel drive motor 44 derived by similar processing.

The processor of the motor ECU 36 receives the information indicating the motor power (the same as the motor power P44 described above) of the rear wheel drive motor 44 transmitted from the motor ECU 37 (step S55).

The processor of the motor ECU 36 acquires, from the memory, the motor loss of the own motor determined by a combination of the torque instruction value received in step S51 and the rotation speed acquired in step S53, and derives the estimated power (the same as the estimated power Pf described above) of the own motor based on the acquired motor loss, torque instruction value, and rotation speed (step S56).

Next, the processor of the motor ECU 36 adds the motor power of the own motor derived in step S54 and the motor power of another motor (the rear wheel drive motor 44) received in step S55 to derive the total motor power PM. The method of deriving the total motor power PM is as described above. Then, the processor of the motor ECU 36 derives the correction amount (discharging correction amount or charging correction amount) of the power limit value received in step S52 based on the derived total motor power PM and the BAT power PB received in step S52 (step S57).

In step S57, as described in FIG. 5, the processor of the motor ECU 36 delays the total motor power PM and derives the difference value between the delayed total motor power PM′ and the BAT power PB as the correction amount of the power limit value. The difference value is a power loss occurring in the power path from the battery 20 to each motor and is described as a power loss ΔP3.

Next, the processor of the motor ECU 36 derives a control power limit value for the two motors as a whole based on the power limit value received in step S52 and the correction amount derived in step S57 (step S58).

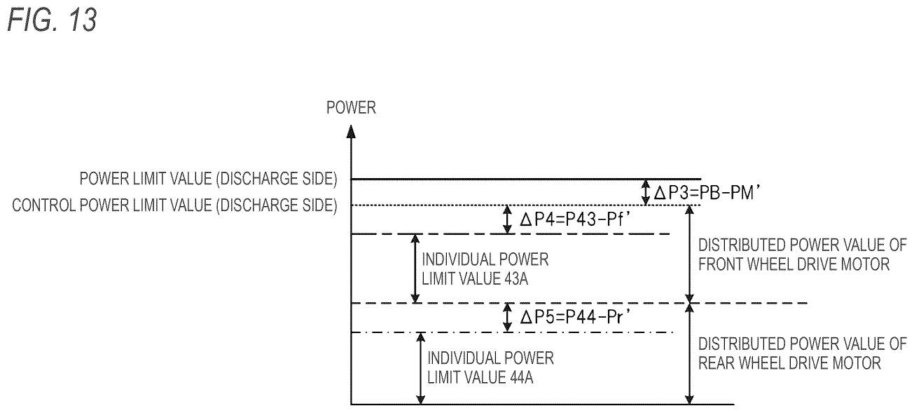

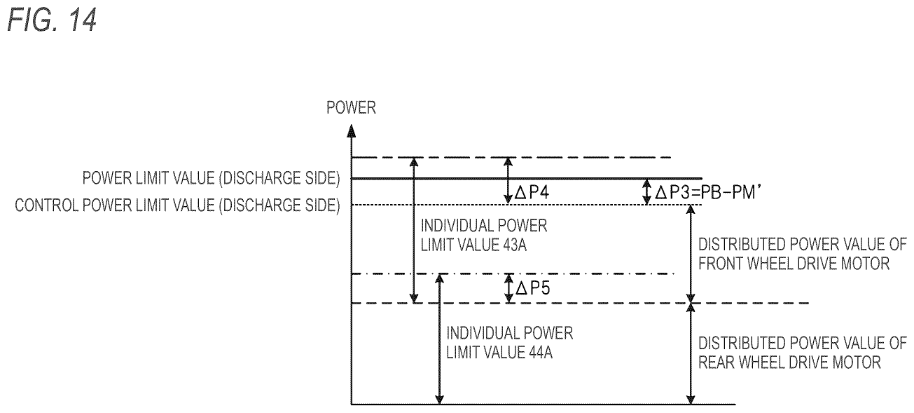

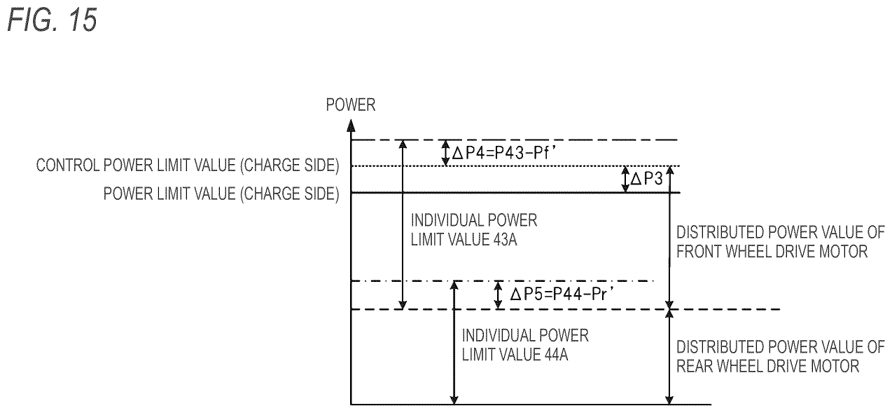

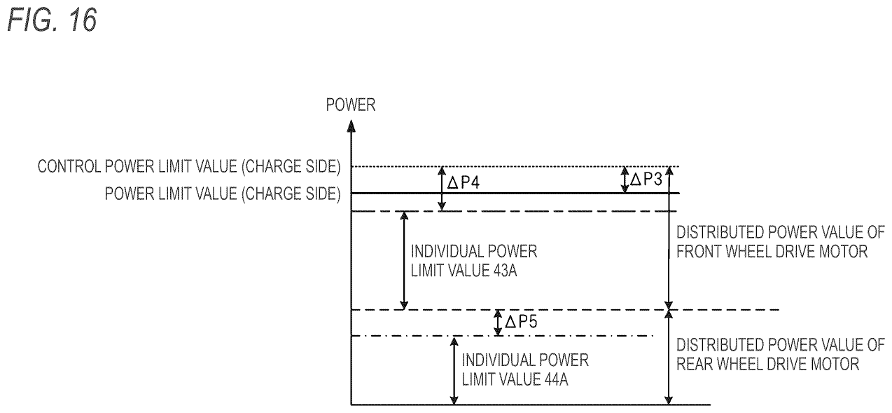

FIGS. 13 and 14 are schematic diagrams each showing a relationship between the discharge-side power limit value and the discharge-side control power limit value. FIGS. 15 and 16 are schematic diagrams each showing a relationship between the charge-side power limit value and the charge-side control power limit value.

In step S58, the processor of the motor ECU 36 derives, as the discharge-side control power limit value, a value obtained by subtracting the correction amount (power loss ΔP3) derived in step S57 from the discharge-side power limit value (see FIGS. 13 and 14).

In step S58, the processor of the motor ECU 36 derives the charge-side control power limit value by adding the correction amount (power loss ΔP3) derived in step S57 to the charge-side power limit value (see FIGS. 15 and 16).

Next, the processor of the motor ECU 36 distributes the control power limit value derived in step S58 to each motor based on an axle torque ratio of the front wheel drive motor 43 and the rear wheel drive motor 44, and derives the distributed power value of the own motor (see FIGS. 13 and 14) (step S59). For example, when the axle torque ratio of the front wheel drive motor 43 and the rear wheel drive motor 44 is 2:1, ⅔ of the control power limit value is derived as the distributed power value of the own motor.

Next, the processor of the motor ECU 36 derives an error of the motor loss of the own motor based on the estimated power Pf of the own motor derived in step S56 and the motor power P43 of the own motor derived in step S54 (step S60).

In step S60, as described in FIG. 4, when the estimated power Pf of the own motor exceeds an immediately preceding individual power limit value (details will be described later) of the own motor, the processor of the motor ECU 36 corrects the estimated power Pf to the individual power limit value, delays the corrected estimated power Pf, and derives a difference value between a delayed estimated power Pf and the motor power P43 of the own motor as an error ΔP4 of the motor loss of the own motor. The error ΔP4 takes a positive value in a direction in which the loss increases and takes a negative value in a direction in which the loss decreases.

Next, the processor of the motor ECU 36 derives the individual power limit value corresponding to the own motor based on the distributed power value derived in step S59 and the error ΔP4 derived in step S60 (step S61).

In step S61, when the error ΔP4 takes a positive value (the loss of the own motor is larger than expected), as shown in FIG. 13, a value obtained by subtracting the error ΔP4 (positive value) from the distributed power value of the front wheel drive motor 43 is derived as an individual power limit value 43A of the front wheel drive motor 43.

When the error ΔP4 takes a negative value (the loss of the own motor is smaller than expected), as shown in FIG. 14, a value obtained by subtracting the error ΔP4 (negative value) from the distributed power value of the front wheel drive motor 43, that is, a value obtained by adding an absolute value of the error ΔP4 to the distributed power value of the front wheel drive motor 43 is derived as the individual power limit value 43A of the front wheel drive motor 43 (see FIG. 14).

The processes of step S51 to step S61 are also performed in the processor of the motor ECU 37. In FIGS. 13 and 14, an error derived by the processor of the motor ECU 37 in the process of step S60 is described as an error ΔP5.

The error ΔP5 is derived as a difference value between the estimated power Pr′ obtained by delaying the estimated power Pr of the rear wheel drive motor 44 and the motor power P44 of the rear wheel drive motor 44. The error ΔP5 takes a positive value in a direction in which the loss increases and takes a negative value in a direction in which the loss decreases.

When the error ΔP5 takes a positive value, as shown in FIG. 13, a value obtained by subtracting the error ΔP5 (positive value) from the distributed power value of the rear wheel drive motor 44 is derived as an individual power limit value 44A of the rear wheel drive motor 44.

When the error ΔP5 takes a negative value, as shown in FIG. 14, a value obtained by subtracting the error ΔP5 (negative value) from the distributed power value of the rear wheel drive motor 44, that is, a value obtained by adding an absolute value of the error ΔP5 to the distributed power value of the rear wheel drive motor 44 is derived as the individual power limit value 44A of the rear wheel drive motor 44.

After step S61, the processor of the motor ECU 36 derives a power correction amount of the estimated power of the own motor (a difference between the estimated power and the individual power limit value when the estimated power exceeds the individual power limit value) based on the individual power limit value derived in step S61 and the estimated power of the own motor derived in step S56 (step S62).

After step S62, the processor of the motor ECU 36 performs correction to decrease the estimated power of the own motor by the power correction amount derived in step S62 (step S63). That is, the estimated power of the own motor is controlled so as not to exceed the individual power limit value.

Next, the processor of the motor ECU 36 converts the corrected estimated power of the own motor into a torque in consideration of the motor loss of the own motor (step S64).

Next, the processor of the motor ECU 36 corrects the torque instruction value of the own motor such that the torque instruction value of the own motor received in step S51 matches the converted torque obtained in step S64 (step S65).

Thereafter, the processor of the motor ECU 36 performs control to drive the own motor according to the torque instruction value corrected in step S65 (step S66).

In the example shown in FIG. 13, an upper limit of power consumption of the front wheel drive motor 43 that operates as an electric motor according to the corrected torque instruction value is a value obtained by adding the error ΔP4 to the individual power limit value 43A (=distributed power value of the front wheel drive motor 43). Further, an upper limit of power consumption of the rear wheel drive motor 44 that operates as an electric motor according to the corrected torque instruction value is a value obtained by adding the error ΔP5 to the individual power limit value 44A (=distributed power value of the rear wheel drive motor 44). Then, when the front wheel drive motor 43 and the rear wheel drive motor 44 operate according to the respective corrected torque instruction values, the power loss ΔP3 occurs.

Therefore, power consumed from the battery 20 when the front wheel drive motor 43 and the rear wheel drive motor 44 operate according to the respective corrected torque instruction values is a sum of the distributed power value of the front wheel drive motor 43, the distributed power value of the rear wheel drive motor 44, and the power loss ΔP3, and the sum matches the discharge-side power limit value.

Therefore, by correcting the torque instruction value of the front wheel drive motor 43 such that the estimated power of the front wheel drive motor 43 does not exceed the individual power limit value 43A and correcting the torque instruction value of the rear wheel drive motor 44 such that the estimated power of the rear wheel drive motor 44 does not exceed the individual power limit value 44A, the power output from the battery 20 can be made equal to or less than the discharge-side power limit value.

In the example shown in FIG. 14, an upper limit of the power consumption of the front wheel drive motor 43 that operates as an electric motor according to the corrected torque instruction value is a value obtained by subtracting the error ΔP4 from the individual power limit value 43A (=distributed power value of the front wheel drive motor 43). Further, an upper limit of the power consumption of the rear wheel drive motor 44 that operates as an electric motor according to the corrected torque instruction value is a value obtained by subtracting the error ΔP5 from the individual power limit value 44A (=distributed power value of the rear wheel drive motor 44). Then, when the front wheel drive motor 43 and the rear wheel drive motor 44 operate according to the respective corrected torque instruction values, the power loss ΔP3 occurs. Therefore, as in the case of FIG. 13, the power output from the battery 20 can be made equal to or less than the discharge-side power limit value.

In the example shown in FIG. 15, an upper limit of generated power of the front wheel drive motor 43 that operates as an electric generator according to the corrected torque instruction value is a value obtained by subtracting the error ΔP4 from the individual power limit value 43A (=distributed power value of the front wheel drive motor 43). Further, an upper limit of the generated power of the rear wheel drive motor 44 that operates as an electric generator according to the corrected torque instruction value is a value obtained by subtracting the error ΔP5 from the individual power limit value 44A (=distributed power value of the rear wheel drive motor 44). Then, when the front wheel drive motor 43 and the rear wheel drive motor 44 operate according to the respective corrected torque instruction values, the power loss ΔP3 occurs.

Therefore, the power input to the battery 20 when the front wheel drive motor 43 and the rear wheel drive motor 44 operate according to the respective corrected torque instruction values takes a value obtained by subtracting the power loss ΔP3 from a sum of the distributed power value of the front wheel drive motor and the distributed power value of the rear wheel drive motor, and the value matches the charge-side power limit value.

Therefore, by correcting the torque instruction value of the front wheel drive motor 43 such that the estimated power of the front wheel drive motor 43 does not exceed the individual power limit value 43A and correcting the torque instruction value of the rear wheel drive motor 44 such that the estimated power of the rear wheel drive motor 44 does not exceed the individual power limit value 44A, the power input to the battery 20 can be made equal to or less than the charge-side power limit value.

In the example shown in FIG. 16, an upper limit of the generated power of the front wheel drive motor 43 that operates as an electric generator according to the corrected torque instruction value is a value obtained by adding the error ΔP4 to the individual power limit value 43A (=distributed power value of the front wheel drive motor 43). Further, an upper limit of the generated power of the rear wheel drive motor 44 that operates as an electric generator according to the corrected torque instruction value is a value obtained by adding the error ΔP5 to the individual power limit value 44A (=distributed power value of the rear wheel drive motor 44). Then, when the front wheel drive motor 43 and the rear wheel drive motor 44 operate according to the respective corrected torque instruction values, the power loss ΔP3 occurs. Therefore, as in the case of FIG. 15, the power input to the battery 20 can be made equal to or less than the charge-side power limit value.

As described above, according to the vehicle 200, the motor ECU (motor ECU 36, motor ECU 37) provided corresponding to each motor can derive the individual power limit value of the corresponding motor. In this way, the individual power limit value and the estimated power are derived for each motor, and the torque instruction value can be corrected based on the individual power limit value and the estimated power. Therefore, for example, as compared with a configuration in which the motor ECU 36 and the motor ECU 37 are replaced with one ECU, torque correction of each motor can be performed at high speed.

In the present specification, at least the following matters are described. Although corresponding constituent elements or the like in the embodiment described above are shown in parentheses, the present invention is not limited thereto.

(1) A motor control device (PCU 3) provided in a vehicle (vehicle 100) equipped with a motor (front wheel drive motor 43, rear wheel drive motor 44, and power generation motor 45) connected to a battery (battery 20), the motor control device including:
a processor (processor of motor ECU 31), in which
the processor is configured to:
acquire a torque instruction value, a rotation speed, and a power loss of the motor;
derive, based on the torque instruction value, the rotation speed, and the power loss, first power (total estimated power PE) consumed by the motor or output from the motor to the battery in a case where the motor operates to output a torque having the torque instruction value;
acquire a current value and a voltage value of the motor;
derive, based on the current value and the voltage value, second power (total motor power PM) consumed by the motor or output from the motor to the battery;
acquire third power (BAT power PB) output from the battery or input to the battery;
acquire a power limit value (discharge-side power limit value and charge-side power limit value) of the battery;
correct the power limit value based on the first power, the second power, and the third power to derive a control power limit value;
derive a power correction amount of the first power in a case where the first power exceeds the control power limit value;
correct the torque instruction value based on the power correction amount; and
operate the motor according to the corrected torque instruction value.

According to the above (1), since the control power limit value is derived based on the first power, the second power, and the third power, the control power limit value can be appropriately determined in consideration of an error in power loss of the motor or power loss on a power path from the battery to the motor, which may change every moment. Accordingly, the power of the battery can be consumed without waste.

For example, a total value of the error of the power loss in the motor and the power loss on the power path from the battery to the motor can be derived based on the first power, the second power, and the third power. Assuming that the first power is consumed by the motor (during battery discharging), when the torque is output according to a torque target value, a sum of the total value and the first power is actually output from the battery. By setting a value obtained by subtracting the total value from the discharge-side power limit value of the battery as a discharge-side control power limit value and correcting the torque instruction value such that the first power does not exceed the discharge-side control power limit value, even when the torque is output according to the corrected torque instruction value, power output from the battery can be prevented from exceeding the discharge-side power limit value, and the battery during discharging can be protected.

Further, assuming that the first power is input to the battery (during regenerative charging of the battery), when the torque is output according to the torque instruction value, power obtained by subtracting the total value from the first power is actually input to the battery. By setting a value obtained by adding the total value and the charge-side power limit value of the battery as a charge-side control power limit value and correcting the torque instruction value such that the first power does not exceed the charge-side control power limit value, even when the torque is output according to the corrected torque instruction value, power input to the battery can be prevented from exceeding the charge-side power limit value, and the battery during charging can be protected.

(2) The motor control device according to the above (1), in which the processor is configured to:
in a case where the first power derived based on the torque instruction value exceeds the control power limit value immediately before the torque instruction value is acquired, correct the first power to the control power limit value; and
derive the control power limit value based on power (delayed total estimated power PE′) obtained by delaying the corrected first power, the second power, power (delayed total motor power PM′) obtained by delaying the second power, and the third power.

(3) The motor control device according to the above (2), in which the processor is configured to:
derive a first difference value (error ΔP1) between the power obtained by delaying the corrected first power and the second power;
derive a second difference value (power loss ΔP2) between the power obtained by delaying the second power and the third power; and
correct the power limit value based on the first difference value and the second difference value to derive a new control power limit value.

(4) The motor control device according to the above (3), in which the processor is configured to:
derive the control power limit value by subtracting a value that is based on the first difference value and the second difference value from the power limit value or adding the value that is based on the first difference value and the second difference value to the power limit value.

(5) The motor control device according to any one of the above (1) to (4), in which
a plurality of the motors are provided, and
the processor is configured to derive each of the first power and the second power as a total value of power consumed by each of the plurality of motors or output from each of the plurality of motors.

(6) The motor control device according to the above (5), in which
the plurality of motors include a first motor (front wheel drive motor 43) for driving a first wheel (front wheel) of the vehicle and a second motor (rear wheel drive motor 44) for driving a second wheel (rear wheel) of the vehicle, and
the processor is configured to correct at least one of the torque instruction value for the first motor and the torque instruction value for the second motor based on the power correction amount, a rotational speed of a wheel driven by the first motor, and a rotational speed of a wheel driven by the second motor, in a case where the first power is consumed by the motors and the first power exceeds the control power limit value.

(7) The motor control device according to the above (6), in which
the plurality of motors further include a third motor (power generation motor 45) for power generation connected to an internal combustion engine of the vehicle, and
the processor is configured to correct the torque instruction value for the third motor based on the power correction amount, in a case where the first power is output from the motors to the battery and the first power exceeds the control power limit value.

What is claimed is:

1. A motor control device provided in a vehicle equipped with a motor connected to a battery, the motor control device comprising:
a processor, wherein
the processor is configured to:
acquire a torque instruction value, a rotation speed, and a power loss of the motor;
derive, based on the torque instruction value, the rotation speed, and the power loss, first power consumed by the motor or output from the motor to the battery in a case where the motor operates to output a torque having the torque instruction value;
acquire a current value and a voltage value of the motor;
derive, based on the current value and the voltage value, second power consumed by the motor or output from the motor to the battery;
acquire third power output from the battery or input to the battery;
acquire a power limit value of the battery;
correct the power limit value based on the first power, the second power, and the third power to derive a control power limit value;
derive a power correction amount of the first power in a case where the first power exceeds the control power limit value;
correct the torque instruction value based on the power correction amount; and
operate the motor according to the corrected torque instruction value.

2. The motor control device according to claim 1, wherein
the processor is configured to:
in a case where the first power derived based on the torque instruction value exceeds the control power limit value immediately before the torque instruction value is acquired, correct the first power to the control power limit value; and
derive the control power limit value based on power obtained by delaying the corrected first power, the second power, power obtained by delaying the second power, and the third power.

3. The motor control device according to claim 2, wherein
the processor is configured to:
derive a first difference value between the power obtained by delaying the corrected first power and the second power;
derive a second difference value between the power obtained by delaying the second power and the third power; and
correct the power limit value based on the first difference value and the second difference value to derive a new control power limit value.

4. The motor control device according to claim 3, wherein
the processor is configured to:
derive the control power limit value by subtracting a value that is based on the first difference value and the second difference value from the power limit value or adding the value that is based on the first difference value and the second difference value to the power limit value.

5. The motor control device according to claim 1, wherein
a plurality of the motors are provided; and
the processor is configured to derive each of the first power and the second power as a total value of power consumed by each of the plurality of motors or output from each of the plurality of motors.

6. The motor control device according to claim 5, wherein
the plurality of motors include a first motor for driving a first wheel of the vehicle and a second motor for driving a second wheel of the vehicle, and
the processor is configured to correct at least one of the torque instruction value for the first motor and the torque instruction value for the second motor based on the power correction amount, a rotational speed of a wheel driven by the first motor, and a rotational speed of a wheel driven by the second motor, in a case where the first power is consumed by the motors and the first power exceeds the control power limit value.

7. The motor control device according to claim 6, wherein
the plurality of motors further include a third motor for power generation connected to an internal combustion engine of the vehicle, and
the processor is configured to correct the torque instruction value for the third motor based on the power correction amount, in a case where the first power is output from the motors to the battery and the first power exceeds the control power limit value.
